(19) United States
(12) Patent Application Publication
(10) Pub. No.: US 2026/0002630 A1
(43) Pub. Date: Jan. 1, 2026

(54) ADJUSTABLE INFORMATION HANDLING DEVICE STAND

(71) Applicant: Lenovo (United States) Inc., Morrisville, NC (US)

(72) Inventors: Cyan Godfrey, Chapel Hill, NC (US); Ghwang-Hyun Lim, Cary, NC (US)

(21) Appl. No.: 18/758,825

(22) Filed: Jun. 28, 2024

(51) Int. Cl. F16M 11/12; A47B 23/04; F16M 11/04

(52) U.S. Cl. CPC F16M 11/121; F16M 11/041; F16M 11/10; A47B 23/043; F16M 2200/021; F16M 2200/08

(57) ABSTRACT

One embodiment provides a device, including: a base; an arm pivotally coupled to the base at a lower portion of the arm, wherein the arm includes a first hinge and wherein the base is configured to move about a first pivot point of the arm via the first hinge in a parallel rotation direction with respect to the lower portion of the arm; and an attachment plate coupled to an upper portion of the arm, wherein the upper portion of the arm includes a second hinge, wherein the attachment plate is configured to move about a second pivot point of the arm via the second hinge in a parallel rotation direction with respect to the upper portion of the arm. Other aspects are claimed and described.

### BACKGROUND

Modern design of information handling devices is commonly directed to a devices ability to be transported with ease. This design approach typically means that devices need to become increasingly more lightweight and portable. Accordingly, many devices are getting smaller, which provides less space for more traditional components and displays. For example, many of these portable devices may utilize touch screens instead of traditional keyboards and mice. As another example, many of these portable devices may have smaller display screens as compared to a traditional display. While the removal or size reduction of some components make devices more portable and lightweight, this removal or size reduction may cause the user to be less efficient when utilizing the device.

### BRIEF SUMMARY

In summary, one aspect provides a device, including: a base; an arm pivotally coupled to the base at a lower portion of the arm, wherein the arm comprises a first hinge and wherein the base is configured to move about a first pivot point of the arm via the first hinge in a parallel rotation direction with respect to the lower portion of the arm; and an attachment plate coupled to an upper portion of the arm, wherein the upper portion of the arm comprises a second hinge, wherein the attachment plate is configured to move about a second pivot point of the arm via the second hinge in a parallel rotation direction with respect to the upper portion of the arm.

Another aspect provides a device, including: a base; an arm pivotally coupled to a back surface of the base at a lower portion of the arm, wherein the arm includes a first hinge and wherein the base is configured to move about a first pivot point of the arm via the first hinge in a parallel rotation direction with respect to the lower portion of the arm; and an attachment plate coupled to an upper portion of the arm via a pivot mechanism, wherein the attachment plate is configured to move about the pivot mechanism in a perpendicular rotation direction with respect to the upper portion of the arm, wherein the upper portion of the arm includes a second hinge, wherein the attachment plate is configured to move about a second pivot point of the arm via the second hinge in a parallel rotation direction with respect to the upper portion of the arm; wherein the attachment plate includes at least one attachment mechanism for coupling an information handling device to the attachment plate.

A further aspect provides a system, including: a base; an arm pivotally coupled to the base at a lower portion of the arm, wherein the base is configured to move about a pivot point of the arm in a parallel rotation direction with respect to the lower portion of the arm; an attachment plate coupled to an upper portion of the arm, wherein the attachment plate is configured to move about a second pivot point of the arm in a parallel rotation direction with respect to the upper portion of the arm; and an information handling device coupled to the attachment plate.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example adjustable stand for an information handling device.

FIG. 4 illustrates example configurations of an adjustable stand for an information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

With the removal of components, it may become more difficult to utilize devices, particularly for longer periods of time. For example, for many portable devices the display is contained on the face of the device. Thus, when a user is utilizing the device for display output, the user has to hold the device in a particular viewing position. The most comfortable position for holding the device may not be the most comfortable position for viewing the device. For example, a user may find it comfortable to hold the device in their lap, but that requires the viewer to look down, straining their neck. To hold the device in a comfortable position for viewing, the user may strain their arm or hand. Other, larger devices either have monitors or displays that are located on stands for positioning in a comfortable viewing position or have a display that is movable with respect to the rest of the device, thereby allowing for easier positioning for viewing. Additionally, if a user wants to utilize the smaller device in conjunction with other devices, for example, a tablet in conjunction with a traditional display, there is no current solution that allows for the tablet or other smaller device to be positioned so that it is on the same viewing level as the display device.

Accordingly, the described system and method provides an adjustable information handling device stand that may be orientated in a variety of positions dependent on a user preference. The adjustable device stand holds a smaller portable device at different positions so that a user can position the device in a comfortable viewing position and also so the device can be used in conjunction with other devices or displays. The adjustable information handling device stand includes a base, an arm pivotally coupled to the base at a lower portion of the arm, and an attachment plate coupled to an upper portion of the arm. The base may be a weighted base that may assist in supporting a wide range of information handling device while also assuring that the adjustable information handling device stand remains stationary and does not topple over with the addition of a device to the attachment plate.

The arm of the adjustable information handling device stand is also designed in such a way that the arm may assist in supporting an information handling device when coupled to the stand. Additionally, an angle and position of the arm may be adjusted based upon user preference, and may support an information handling device coupled to the stand at any desired angle. The attachment plate coupled to the upper portion of the arm may allow for the attachment of an information handling device to the adjustable information handling device stand. This attachment plate may secure the information handling device when coupled to the adjustable information handling device stand, and may further permit a plurality of orientation adjustments of the information handling device when coupled to the stand. The adjustable information handling device stand may supply a user with a secure device stand that will support a variety of information handling devices at a user preferred viewing orientation.

The illustrated example embodiments will be best understood by reference to the figures. The following description is intended only by way of example, and simply illustrates certain example embodiments.

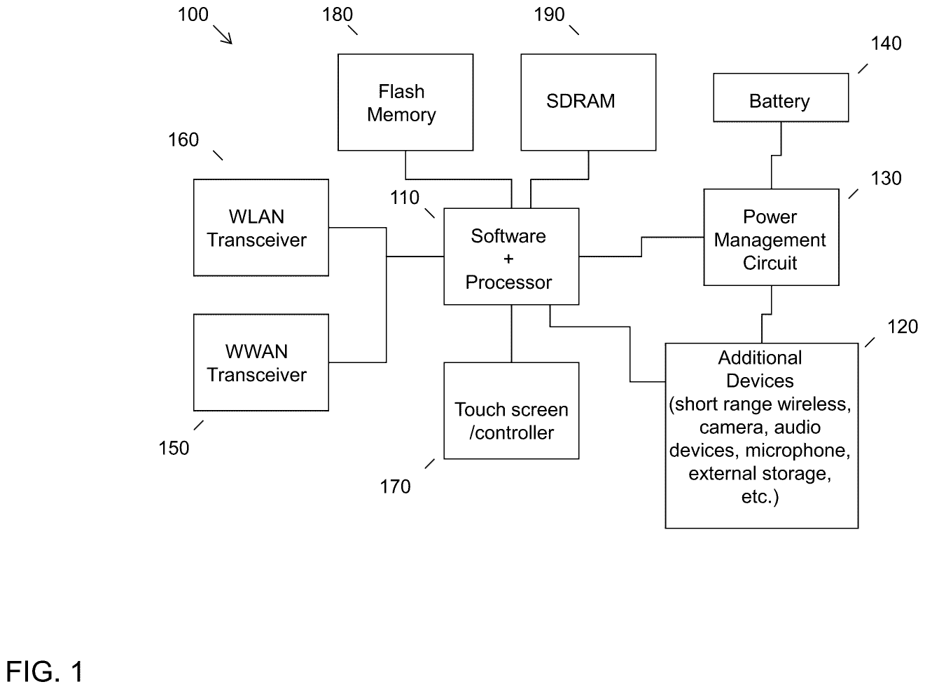

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

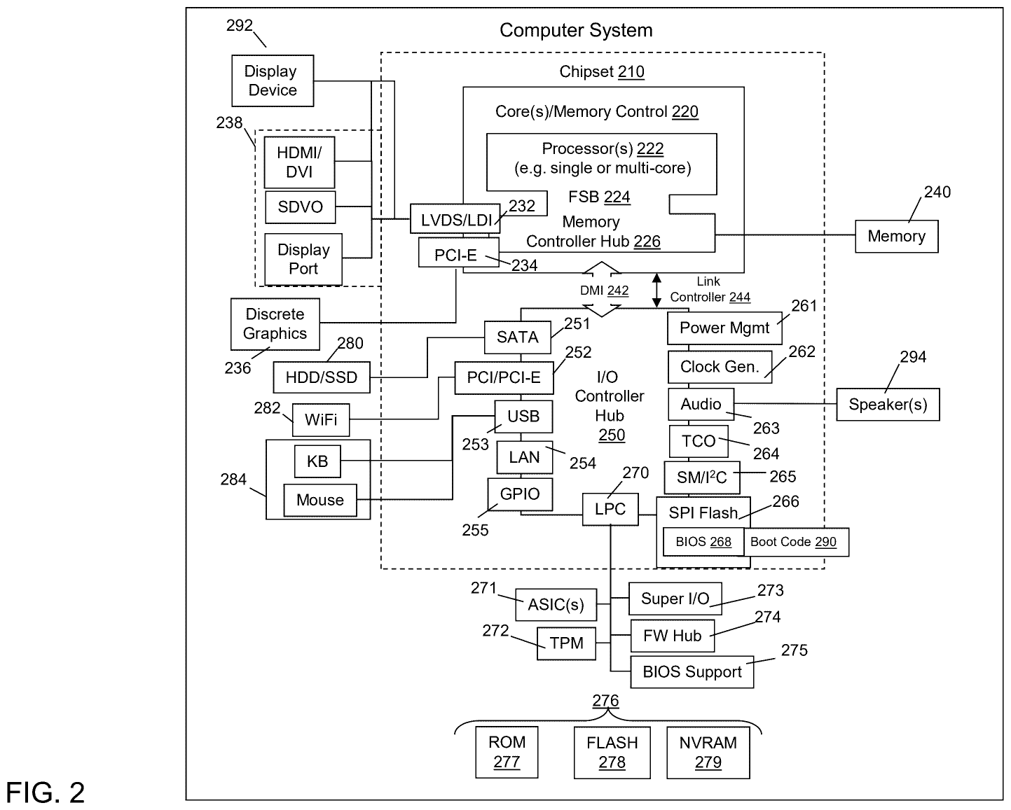

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may used with the adjustable information handling device stand. For example, the circuitry outlined in FIG. 1 may be implemented in a tablet or smart phone embodiment, whereas the circuitry outlined in FIG. 2 may be implemented in a personal computer embodiment.

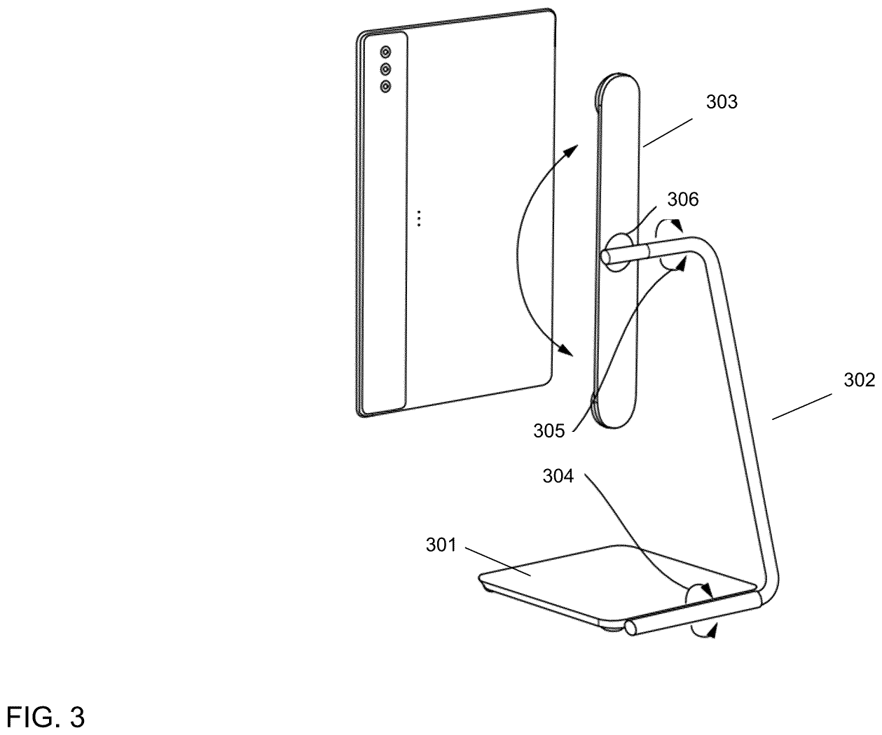

FIG. 3 illustrates an example adjustable information handling device stand. While the system may include known hardware components and/or hardware components developed in the future, the device itself is specifically design to provide a secure information handling device stand that may successfully support a variety of information handling devices at orientation aligned with a user display preference. Additionally, the adjustable information handling device components and features are unique to the described system. Each device stand comprises a base, an arm, and an attachment plate for supporting a coupled information handling device. Throughout the description of the adjustable information handling device stand, the information handling device referred to when coupled to the stand may be tablet; however, this is intended as a non-limiting example. The information handling device can be a tablet, a cell phone, a smart display, a mobile display with no computing capabilities, a handheld device, and/or the like. The adjustable information handling device stand may be orientated to align with user preference while also supporting a device without issues. Additionally, the stand is of a size and design that allows for easy storage of the stand when not in use.

The stand includes a base 301. The base may have different shapes, sizes, and/or designs. The base of the adjustable information handling device may be weighted to ensure that the stand does not move while in use, for example, toppling over from the weight of the device, moving if a surface that the stand is on moves, and/or the like. In this case, a weighted base is a base having a weight that is at least enough to counteract the weight of a device being attached to the stand. As should be understood, since the device would be attached at an elevated position or cantilevered position, the weight of the base would need to be greater than the weight of the device to counteract the weight of the device at the desired position.

One way to weight the base may be to make a large base or a base having a size to ensure the desired weight is met. However, this would increase the size of the base, which may be undesirable in some applications. Thus, another technique for weighting the base is to make the base of a material having a desired weight. This may allow for a smaller base to be utilized, while still obtaining the desired weight of the base. For example, the base of the adjustable stand may be made from a type of metal (e.g., tungsten, platinum, palladium, etc.), high density plastic, wood, and/or the like, or a combination thereof. The utilization of different materials may allow for different sizes of bases.

Additionally, or alternatively, the base may include at least one holding mechanism to attach or hold the base to the surface. The holding mechanism may be used in lieu of or in addition to the weighted base. In other words, instead of a weighted base, the base may be a non-weighted base (i.e., a base not having enough weight to counteract the weight of a device attached to the stand) and instead have holding mechanisms to ensure the stand will not move when a device is attached to the stand. However, the holding mechanism may be used in conjunction with the weighted base. Attaching the base to a surface in which the base lies upon may further assist in securing the adjustable information handling device stand. The holding mechanism may include, for example, a material that may adhere the base to the surface (e.g., a glue-like substance, a sticky strip, tape, and/or the like), a design to increase friction about the bottom of the base (e.g., ridges, a rubber bottom, holding feet, etc.), a suction mechanism, and/or the like, or a combination thereof.

The base of the adjustable information handling stand is coupled to an arm 302 of the adjustable information handling device at a first hinge, at 304. The arm 302 of the adjustable information handling device stand may be pivotally coupled to the base 301 at a lower portion of the arm 302. As can be seen in FIG. 3, the arm 302 is pivotally coupled to the base 301. The arm 302 may be attached to the base 301 by use of a first hinge 304. The base 301 moves about or is configured to move about a first pivot point of the arm 302 via the first hinge 304 in a parallel rotation direction with respect to the lower portion of the arm 302. In other words, the arm 302 can pivot with respect to the base 301 so that the upper portion of the arm moves forwards and backwards around the base 302, thereby allowing a user to adjust the height, with respect to the base, of the upper portion of the arm 302 and the attachment mechanism 303. For example, the base 301 may operate as an x-axis that runs along a surface the adjustable stand is located upon, and the arm 302 may act as the y-axis. With respect to the location of the first hinge 304 acting as a connection point between the lower portion of the arm 302 and the rear side of the base 301, an angle of the arm may be adjusted about these two axes. This angle will be referred to as an angle of influence to distinguish it from other angles.

The first hinge 304 is located at a lower portion of the arm 302 and at the rear surface, or the back, of the base 301. Such a position of the first hinge 304 and the location for connection may further assist in balancing a tablet, or any information handling device, as one is coupled to the adjustable information handling device stand. However, this coupling location is not strictly necessary. The first hinge 304 may be a strong hinge that does not require a locking mechanism for maintaining an angle for the adjustable stand. Additionally, or alternatively, the first hinge may include a locking mechanism (e.g., a placement pin, teeth along the inner portion of the hinge, a ratcheting mechanism, a friction mechanism, etc.) that holds the hinge in a set position, therefore, maintaining an angle between the base 301 and the arm 302.

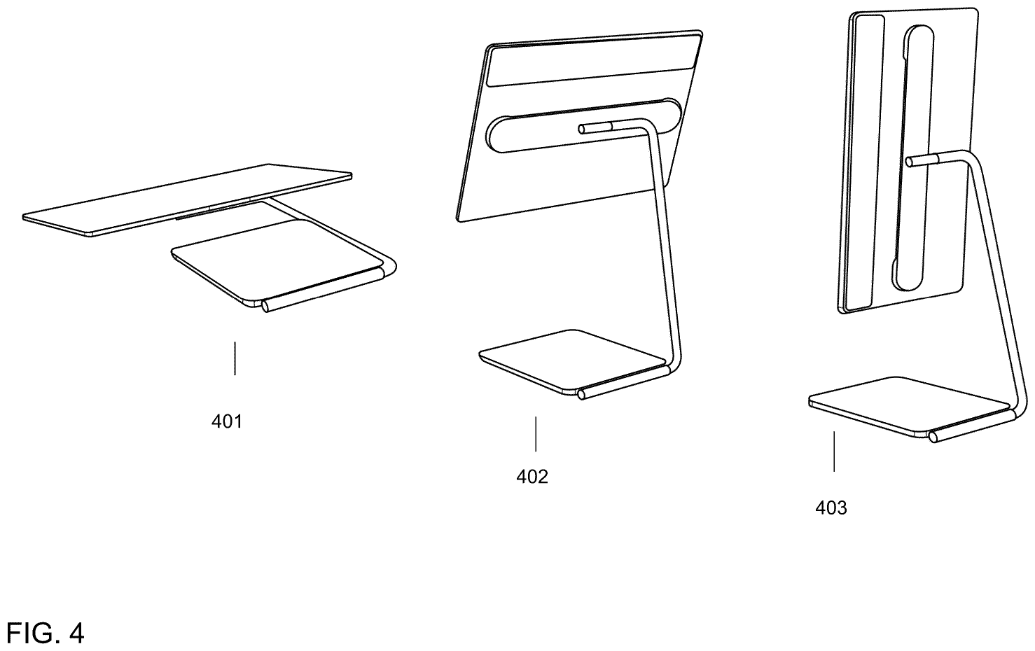

The movement of the arm 302 with respect to the base 301 about the first hinge 304 is expanded upon in FIG. 4. Referring to FIG. 4, the movement of the arm 302 with respect to the base 301 and, therefore, the angle of influence formed at the first hinge 304 is shown at two different locations/angles, specifically, at 401 and 402. As can be seen at 401, the angle of influence formed at the first hinge 304 between the base 301 and the arm 302 is close to zero degrees, or flat. A user may elect to utilize an information handling device attached to the adjustable stand along a flat surface while maintaining a coupling to the adjustable information handling device stand. In such a situation, the parallel rotation of the arm about the base and/or the base about the arm permits the flattening, or folding, of the arm 302 to be about the same plane as the base 301. Additionally, or alternatively, the parallel rotation of the arm 302 may fall below the base 301.

Additionally, and still referring to the FIG. 4, the angle of influence of the first hinge 304 at orientation 402 shows a more traditional use of the adjustable information handling device stand. In 402, the arm 302 is positioned in a more upright orientation as compared to 401, supporting an information handling device attached to the stand at a higher position in comparison to 401. The angle between the base 301 and the arm 302 is far greater at 402, and this is because the arm 302 is in that upright position. At an angle as shown at 402, the first hinge 304 may include a locking mechanism to ensure that the angle of the arm 302 remains while in use. In other words, the hinge may include a mechanism or may be designed so that the arm does not fall from the position shown in 402 to the position shown in 401 without the user moving it to this position.

Referring back to FIG. 3, the arm 302 may also include an upper portion of the arm 302 that may be coupled to the attachment plate 303. In the example illustrated in the figures, the arm 302 is made up of three total portions. A lower portion coupled the base 301, an upper portion coupled to an attachment plate 303 and a pivot mechanism 306, and a middle portion that joins the upper and lower portions of the arm 302 together. In this example, the upper portion of the arm 302 and the lower portion of the arm 302 are parallel to each other. In other words, the orientation of the upper and lower portions extends outward from the middle portion in the same direction in a C-type shape. This can be seen as illustrated in both FIG. 3 and FIG. 4, specifically, at the coupling locations of each portion. The middle portion of the arm 302 simply pairs the upper and lower portions together. Additionally, the middle portion of the arm may include a telescoping device allowing for a change in length of the middle portion of the arm 302. In other words, a telescoping middle portion of the arm 302 may permit an adjustment to the height of the adjustable information handling device stand. However, this configuration of the arm 302 is not strictly necessary, as different shapes and configurations are contemplated and possible, for example, the arm may be an S-type shape, I-type shape, squiggle shape, and/or the like.

The attachment plate 303 may be coupled to an upper portion of the arm 302 at a location including a second hinge 305. The attachment plate 303 and the upper portion of the arm 302 may produce an angle for display since the attachment plate 303 will be attached to a device being supported by the adjustable information handling device stand. The second pivot point, or the second hinge 305, may also be adjusted in a parallel rotation direction with respect to the upper portion of the arm 302. In other words, the parallel rotation between the attachment plate 303 and the upper portion of the arm 302 may also operate about an x-axis and a y-axis. However, at this new location, the attachment plate 303 acts along the x-axis (whereas the base acts as the x-axis about the first hinge 304). The angle of display, or the angle produced between the attachment plate 303 and the upper portion of the arm 302, is adjustable by the user. Similar to the first hinge 304, the second hinge 305 may contain a locking mechanism to hold the second hinge 305 at a locked position. Additionally, or alternatively, the second hinge 305 may be a strong hinge that may not require the use of a locking mechanism. It should be noted that none, one, or both of the hinges may include a locking mechanism. In other words, just because one hinge may include a locking mechanism, does not necessarily mean that both hinges will include a locking mechanism. Additionally, even if both hinges include locking mechanisms, both hinges do not have to include the same type of locking mechanism. For example, one hinge may have a ratcheting locking mechanism and the other hinge may have a friction locking mechanism.

The attachment plate 303 may be utilized to attach an information handling device in use by a user, to the adjustable information handling device stand. The attachment plate 303 includes an attachment mechanism for coupling an information handling device to the attachment plate 303. The attachment mechanism may securely couple a device to the attachment plate 303 to ensure that once a device is connected, the device will remain connected until removed by a user. The attachment mechanism may utilize at least one type of attachment mechanism to perform a strong coupling. For example, the attachment mechanism may utilize one or more magnets. A device may be positioned in such a way about the attachment plate 303 that the magnets of the attachment mechanism may secure a device to the attachment plate 303. Therefore, when a user backs away from the device, the adjustable information handling device stand supports the coupled device. The magnets of the attachment plate 303 may align with magnets that may be included in the information handling device. For example, some information handling devices include magnets on a back surface that can be utilized to hold a cover, keyboard attachment, and/or the like. Thus, the magnets of the attachment plate 303 may be positioned on the attachment plate 303 so that they align with the magnets already included in the information handling device. Alternatively, or additionally, a user could place magnets on the device or a cover of the device to align with the magnets of the attachment plate 303.

Additionally, or alternatively, a variety of attachment mechanisms may be used, for example, the magnets, a suction device, a fastener, an adhesive, and/or the like, or a combination thereof. The attachment plate 303 may employ one type of attachment mechanism for coupling a device. Additionally, or alternatively, the attachment plate 303 may employ a combination of attachment mechanisms for coupling a device to the attachment plate 303, and overall, the adjustable information handling device stand.

The coupling of the attachment plate 303 to the upper portion of the arm 302 may also include utilizing pivot mechanism 306. The attachment plate 303 is coupled to the upper portion of the arm 302 at second hinge 305. A pivot mechanism 306 may also be included between the attachment plate 303 and the upper portion of the arm 302 to permit the attachment plate 303 to move in a perpendicular rotation direction with respect to the upper portion of the arm 302. In other words, rather than the attachment plate 303 being limited to move about a second hinge 305 in a parallel direction, the attachment plate 303 may move about a z-axis with respect to the upper portion of the arm 302. The pivot mechanism 306, operating about a z-axis, may permit the movement of a device coupled to the attachment mechanism 303 to move in a circular orientation with respect to a direction that a device is facing. For example, a device that is coupled to the attachment plate 303 in a portrait orientation may rotate about the pivot mechanism into a landscape orientation. The pivot mechanism 306 may allow a full rotation (e.g., 360 degrees). Alternatively, the pivot mechanism 306 may allow rotation less than a full rotation.

Additionally, the attachment plate 303 may be removable from the stand. Thus, the attachment plate 303 may be coupled to the upper portion of the arm 302 utilizing a removable attachment mechanism, for example, a ball and socket, clips and receivers, screws, and/or the like.

Referring back to FIG. 4, rotation about a pivot mechanism 306 of the attachment plate 303 is illustrated between configuration 402 and configuration 403. Configuration 402 and configuration 403 illustrate a similar angle of influence between the arm 302 and the base 301. However, the orientation of the device is different between configuration 402 and 403. As illustrated in orientation 402, the device coupled to attachment plate 303 may be orientated in a landscape viewing mode. Through the use of the pivot mechanism 306, the device may be rotated to a portrait viewing mode, as illustrated in configuration 403. Orientation of the device (device movement about the pivot mechanism 306) and the angle of display (device movement about the second hinge 305) may work individually and/or in combination with one another.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A device, comprising:
a base;
an arm pivotally coupled to the base at a lower portion of the arm, wherein the arm comprises a first hinge and wherein the base is configured to move about a first pivot point of the arm via the first hinge in a parallel rotation direction with respect to the lower portion of the arm; and
an attachment plate coupled to an upper portion of the arm, wherein the upper portion of the arm comprises a second hinge and a pivot mechanism, wherein the attachment plate is configured to move about a second pivot point of the arm via the second hinge in a parallel rotation direction with respect to the upper portion of the arm, wherein the pivot mechanism is present between the attachment plate and the upper portion of the arm and wherein the attachment plate is configured to move about the pivot mechanism in a perpendicular rotation direction with respect to the upper portion of the arm.

2. The device of claim 1, wherein the base comprises a weighted base.

3. The device of claim 1, wherein the base comprises at least one holding mechanism to attach the base to a surface.

4. (canceled)

5. The device of claim 1, wherein the pivot mechanism allows full rotation about the pivot mechanism.

6. The device of claim 1, wherein the lower portion of the arm and the upper portion of the arm are parallel to each other and connected together via a middle portion of the arm.

7. The device of claim 1, wherein the lower portion of the arm is coupled to the base at a rear surface of the base.

8. The device of claim 1, wherein the attachment plate comprises at least one attachment mechanism for coupling to an information handling device.

9. The device of claim 8, wherein the at least one attachment mechanism comprises at least one attachment mechanism selected from the group consisting of: a magnet, a suction device, a fastener, and an adhesive.

10. The device of claim 1, wherein the arm comprises a middle portion, wherein the middle portion comprises a telescoping device allowing for a change in length of the middle portion.

11. The device of claim 1, wherein the first hinge comprises a locking mechanism that holds the first hinge in a set position.

12. The device of claim 1, wherein the second hinge comprises a locking mechanism that holds the second hinge in a set position.

13. A device, comprising:
a base;
an arm pivotally coupled to a back surface of the base at lower portion of the arm, wherein the arm comprises a first hinge and wherein the base is configured to move about a first pivot point of the arm via the first hinge in a parallel rotation direction with respect to the lower portion of the arm; and
an attachment plate coupled to an upper portion of the arm via a pivot mechanism, wherein the pivot mechanism is present between the attachment plate and the upper portion of the arm, wherein the attachment plate is configured to move about the pivot mechanism in a perpendicular rotation direction with respect to the upper portion of the arm, wherein the upper portion of the arm comprises a second hinge, wherein the attachment plate is configured to move about a second pivot point of the arm via the second hinge in a parallel rotation direction with respect to the upper portion of the arm, wherein the attachment plate comprises at least one attachment mechanism for coupling an information handling device to the attachment plate.

14. The device of claim 13, wherein the base comprises a weighted base.

15. The device of claim 13, wherein the base comprises at least one holding mechanism to attach the base to a surface.

16. The device of claim 13, wherein the lower portion of the arm and the upper portion of the arm are parallel to each other and connected together via a middle portion of the arm.

17. The device of claim 13, wherein the pivot mechanism allows full rotation about the pivot mechanism.

18. The device of claim 13, wherein at least one of the first hinge and the second hinge comprises a locking mechanism that holds the at least one of the first hinge and the second hinge in a set position.

19. The device of claim 13, wherein the arm comprises a middle portion, wherein the middle portion comprises a telescoping device allowing for a change in length of the middle portion.

20. A system, comprising:
a base;
an arm pivotally coupled to the base at a lower portion of the arm, wherein the base is configured to move about a pivot point of the arm in a parallel rotation direction with respect to the lower portion of the arm;
an attachment plate coupled to an upper portion of the arm, wherein the attachment plate is configured to move about a second pivot point of the arm in a parallel rotation direction with respect to the upper portion of the arm, wherein the upper portion of the arm comprises a pivot mechanism at the second pivot point further permitting movement about the pivot mechanism in a perpendicular rotation direction with respect to the upper portion of the arm; and
an information handling device coupled to the attachment plate.
